(19) United States
(12) Patent Application Publication
(10) Pub. No.: US 2022/0335770 A1
(43) Pub. Date: Oct. 20, 2022

(54) BLADE HOLDER SYSTEM BASED ON RADIO FREQUENCY IDENTIFICATION TECHNOLOGY AND CONTROLLING METHOD THEREOF

(71) Applicant: LEICA MICROSYSTEMS LTD., SHANGHAI, Pudong, Shanghai (CN)

(72) Inventors: Song JIN, Pudong, Shanghai (CN); Jue CHEN, Pudong, Shanghai (CN)

(21) Appl. No.: 17/642,598

(22) PCT Filed: Sep. 12, 2019
(86) PCT No.: PCT/CN2019/105566

§ 371 Date: Mar. 11, 2022

(51) Int. Cl. G07F 11/62; G06K 7/10; G06K 19/07

(52) U.S. Cl. CPC G07F 11/62; G06K 7/10366; G06K 19/0723

(57) ABSTRACT

Embodiments of the present disclosure relate to a blade holder system based on radio frequency identification (RFID) technology and a controlling method thereof. The blade holder system comprises a blade dispenser, including a blade and a radio frequency identification (RFID) tag, the RFID tag including ID data relating to the blade dispenser; a blade holder, including a radio frequency identification (RFID) reading/writing unit, configured to establish a wireless communication connection with the RFID tag so as to receive the ID data from the RFID tag; and a controller, configured to receive the ID data from the RFID reading/writing unit, to compare the ID data with preset authorization data, and to enable the blade holder to use the blade in the blade dispenser when the ID data matches with the authorization data.

### TECHNICAL FIELD

The present disclosure relates to a field of blade holders, and particularly to a blade holder system based on radio frequency identification (RFID) technology and a controlling method thereof.

### BACKGROUND

In the art, microtomes are used, for example, to prepare thin sections of tissue that can then be investigated microscopically. In the laboratory, a disposable blade is commonly used, which may be disposed of after a number of sectioning operations and replaced with a new blade. For this purpose, the microtomes may include a blade holder system, generally including a blade holder for installing a blade and a blade dispenser for holding the blades. In the blade dispenser, new blades may be held in a blade supply container in which a blade stack made up of multiple blades is received. When the blade dispenser is installed on the blade holder, the blade holder may control and drive the blade dispenser to take a new blade out of the blade supply container of the blade dispenser and to deliver it into a blade receptacle in the blade holder, and also to push a used blade to be disposed of to a blade disposal container, which is generally also provided in the blade dispenser. When the blades in the blade supply container have run out, new blades may be replenished simply by replacing the blade dispenser.

However, the above conventional blade holder system may suffer from the following drawbacks.

In the conventional blade holder system, the blade holder generally controls and drives the blade dispenser in a pure mechanical manner, which does not identify or verify the blade dispenser or the blades received in the blade dispenser. Therefore, as long as the blade's mechanical dimension is suitable for the blade holder, blades provided from different blade manufacturers may be used on the same blade holder. However, cutting qualities of the blades provided by different manufacturers trend to be different. As a result, the qualities of the sections prepared by those blades also become very different. As for applications requiring high precision and high stability, such difference in cutting qualities would be unacceptable.

Therefore, an object of the present disclosure is to provide a scheme capable of ensuring uniformity of the blades to be used and the consistency and stability of the cutting quality by identifying and verifying the blade dispenser installed on the blade holder based on the RFID technology.

### SUMMARY

Accordingly, the present disclosure is directed to a blade holder system based on RFID technology and a controlling method thereof that substantially obviates one or more of the problems due to limitations and disadvantages of the related art.

One aspect of the present disclosure proposes a blade holder system, comprising: a blade dispenser, including a blade and a radio frequency identification (RFID) tag, the RFID tag including ID data relating to the blade dispenser; a blade holder, including: a radio frequency identification (RFID) reading/writing unit, configured to establish a wireless communication connection with the RFID tag so as to receive the ID data from the RFID tag; and a controller, configured to receive the ID data from the RFID reading/writing unit, to compare the ID data with preset authorization data, and to enable the blade holder to use the blade in the blade dispenser when the ID data matches with the authorization data.

Further, another aspect of the present disclosure proposes a blade holder system, comprising: a blade dispenser including a blade and a radio frequency identification (RFID) tag, the RFID tag including ID data relating to the blade dispenser; a server including a database in which authorization data is stored; a blade holder, including: a radio frequency identification (RFID) reading/writing unit, configured to establish a wireless communication connection with the RFID tag so as to receive the ID data from the RFID tag; and a communicate unit, configured to communicate with the server via a network; and a controller, configured to receive the ID data from the RFID reading/writing unit, to transmit the received ID data to the server through the communication unit, to receive an authorization verification message from the server, and to enable the blade holder to use the blade in the blade dispenser when the authorization verification message indicates successful authorization verification. The server receives the ID data from the controller, compares the ID data with the authorization data in the database to determine whether the ID data matches with the authorization data, and returns the determination result as the authorization verification message back to the controller.

Further, still another aspect of the present disclosure proposes a method for controlling a blade holder system, the blade holder system comprising a blade holder including a radio frequency identification (RFID) reading/writing unit and a blade dispenser including a blade and a radio frequency identification (RFID) tag, the RFID tag including ID data relating to the blade dispenser, the method comprising: establishing, by the radio frequency identification (RFID) reading/writing unit, a wireless communication connection with the RFID tag, so as to receive the ID data from the RFID tag; and comparing the ID data with preset authorization data; and enable the blade holder to use the blade in the blade dispenser when the ID data matches with the authorization data.

Further, other aspects of the present disclosure propose an electronic device, comprising: one or more processors, and a storage device, configured to store one or more programs. When the one or more programs are executed by the one or more processors, the one or more processors are configured to implement the above-mentioned method for controlling a blade holder system.

Further, other aspects of the present disclosure propose a computer readable storage medium having a computer program stored thereon, wherein, when the program is executed by a processor, the program implements the above-mentioned method for controlling a blade holder system.

In the embodiments of the present disclosure, a blade holder system based on the RFID technology and a controlling method thereof is provided, in which the blade holder system comprises a blade holder including a RFID reading/writing unit and a blade dispenser including a blade and a RFID tag, the RFID tag including ID data relating to the blade dispenser. By identifying and verifying the blade dispenser installed on the blade holder based on the RFID technology, it is ensured that the blade holder may always be provided with authorized blade dispensers, thereby being capable of maintaining the uniformity of the blades to be used and the consistency and stability of the cutting quality.

Additional features and advantages of the present disclosure will be set forth in the description which follows, and in part will be apparent from the description, or may be learned by practice of the invention. These and other advantages of the present disclosure will be realized and attained by the structure particularly pointed out in the written description and claims hereof as well as the appended drawings.

It is to be understood that both the foregoing general description and the following detailed description are explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1A illustrates a perspective view of a blade dispenser according to an embodiment of the present disclosure;

FIG. 1B is a sectional view of the blade dispenser in FIG. 1A;

FIG. 2 illustrates a perspective view of a blade holder according to an embodiment of the present disclosure;

FIG. 3 illustrates a schematic diagram of a blade holder system based on RFID technology according to a first embodiment of the present disclosure;

FIG. 4 illustrates a schematic diagram of a blade holder system based on RFID technology according to a second embodiment of the present disclosure;

FIG. 5 illustrates a schematic diagram of a blade holder system based on RFID technology according to a third embodiment of the present disclosure;

FIG. 6 illustrates a flow chart of a method for controlling a blade holder system based on RFID technology according to a fourth embodiment of the present disclosure;

FIG. 7 illustrates a flow chart of a method for decrypting the encrypted ID data according to an embodiment of the present disclosure;

FIG. 8 illustrates a flow chart of a method for controlling a blade holder system implemented with a remote server according to an embodiment of the present disclosure; and

FIG. 9 illustrates a schematic diagram of an electronic device according to an embodiment of the present disclosure.

### DETAILED DESCRIPTION

Reference will now be made in detail to embodiments of the present disclosure, examples of which are illustrated in the accompanying drawings. Throughout the drawings, same or like reference signs always refer to same or like elements or elements having same or like functions.

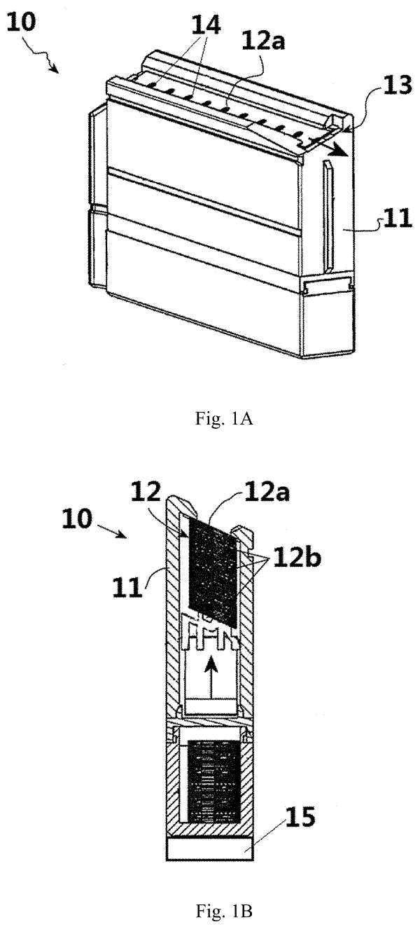

FIG. 1A illustrates a perspective view of a blade dispenser 10 according to an embodiment of the present disclosure. FIG. 1B is a sectional view of the blade dispenser 10 in FIG. 1A.

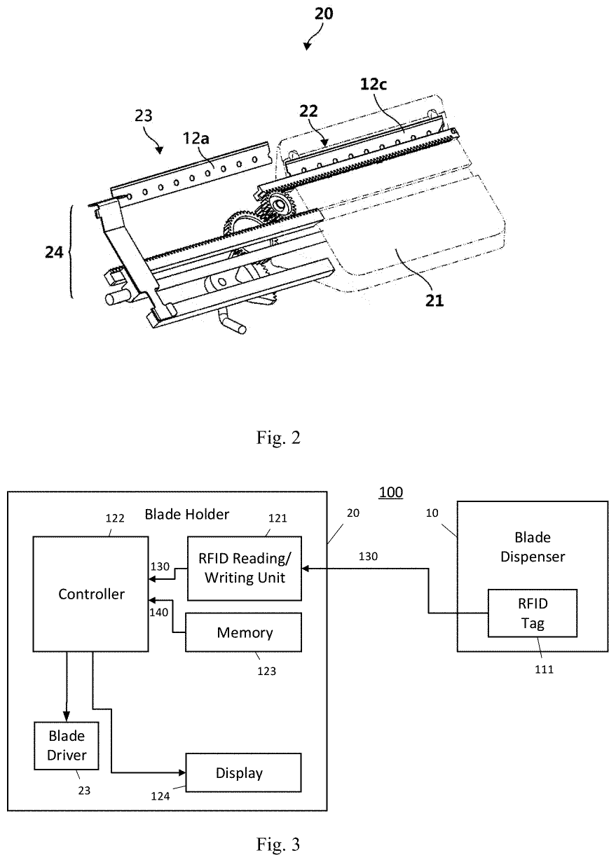

As shown in FIGS. 1A and 1B, the blade dispenser 10 comprises a blade supply container 11. A blade stack 12 made up of a plurality of blades 12a, 12b is received in the blade supply container 11, the uppermost blade being labeled as 12a. The blade 12a can be slid out of a removal position and out of the blade supply container 11 through a blade removal opening 13, to the right side, as indicated by the arrow in FIG. 1A, and removed. Each blade 12a, 12b in the blade stack 12 may include one or more driver engagement opening 14. Particularly, a blade driver 23 in the blade holder, which will be described in detail below with reference to FIG. 2, may engage into the one or more driver engagement opening 14 in order to move the blade, in particular in this case to push it out of the blade removal opening 13 of the blade supply container 11.

As shown in FIG. 1B, a radio frequency identification (RFID) tag 15 may be disposed at the bottom of the blade dispenser 10. However, this illustration only presents an example, and the RFID tag 15 may be disposed at any position of the blade dispenser 10. For example, the RFID tag 15 may be disposed on the sides of or inside the blade dispenser 10. In some embodiments, the RFID tag may be arranged at a position facing a RFID reading/writing unit in the blade holder that will be described in detail later, such that the RFID tag is very close to the RFID reading/writing unit when the blade dispenser 10 is installed on the blade holder, which may facilitate the detection of the presence of the RFID tag by the RFID reading/writing unit.

FIG. 2 illustrates a perspective view of a blade holder 20 according to an embodiment of the present disclosure.

The blade holder 20 includes a blade block 21, a blade receptacle 22 and a blade driver 23.

The blade receptacle 22 is formed on a step portion in an upper region of the blade block 21, for receiving and securing the blade, which defines a cutting position. A blade that is located in the blade receptacle 22 is labelled as 12c. The blade 12c has been taken from the blade stack 12 within the blade supply container 11 (as shown in FIGS. 1A-1B). As indicated by the arrow in FIG. 1A, a new blade 12a may slid out of the blade supply container 11, and is then delivered into the blade receptacle 22, while the used blade 12c to be disposed of will be delivered to a disposal container (not shown).

The blade driver 23 is disposed next to the blade block 21 on its left side, including a driving unit 24. The blade driver 23 may actuate the driving unit 24, to deliver the new blade 12a towards the right, into the blade receptacle 22.

As described above, each blade 12a, 12b in the blade stack 12 comprises one or more driver engagement opening 14 into which the blade driver 23 (specifically, the driving unit 24) can engage in order to push the new blade 12a out of the blade removal opening 13 of the blade supply container 11.

Besides the above mechanical structure, the blade holder 20 may further include electrical structures (not show in FIG. 2) for controlling the operations of the blade holder 20. Hereinafter, the electrical structures and operations of the blade holder 20 will be described in detail with reference to FIGS. 3-5.

It is noted that the structures of the blade holder 20 and the blade dispenser 10 according to the present disclosure have been described with respect to specific examples illustrated in FIGS. 1A, 1B and 2. However, such examples are only intent to facilitate the understanding to the schemes in the present disclosure, and are not intent to limit on the blade holder and the blade dispenser in the present disclosure. It is to be understood that the schemes in the present disclosure may be applied to various kinds of blade holders and blade dispensers based on the following description.

### First Embodiment

FIG. 3 illustrates a schematic diagram of a blade holder system 100 based on radio frequency identification (RFID) technology according to a first embodiment of the present disclosure.

As show in FIG. 3, the blade holder system 100 may comprise a blade dispenser 10 and a blade holder 20.

The blade dispenser 10 may include a blade (not shown) and a radio frequency identification (RFID) tag 111, the RFID tag 111 including ID data relating to the blade dispenser 10.

In the embodiments of the present disclosure, the RFID tag 111 includes at least one of 2.4G RFID tag and 13.56M RFID tag. The 13.56M RFID tag supports contact-type data reading and authorization. The 2.4G RFID tag supports not-contact type, long-distance and multi-target data reading and authorization.

The blade holder 20 may include a radio frequency identification (RFID) reading/writing unit 121, a controller 122, a memory 123 and a display 124.

The RFID reading/writing unit 121 is configured to establish a wireless communication connection with the RFID tag 111 to receive ID data 130 from the RFID tag 111.

Specifically, when the RFID tag 111 approaches a radio frequency energy source, such as the RFID reading/writing unit 121, the RFID tag 111 may be activated. Therefore, when the blade dispenser 10 is installed on the blade holder 20, the RFID reading/writing unit 121 may detect whether there is a RFID tag 111 within a preset range, and establish the wireless communication connection with the detected RFID tag 111.

In the prior art, a conventional blade dispenser is not provided with a RFID tag. Accordingly, when such a conventional blade dispenser is installed on the blade holder 20, the RFID reading/writing unit 121 could not detect a RFID tag. Accordingly, the blade holder 20 will not drive the conventional blade dispenser. In this way, the usage of non-authorized blades with unknown blade quality may be avoided.

On the other hand, in the embodiments of the present disclosure, the RFID tag 111 is provided on the blade dispenser 10. Accordingly, when the blade dispenser 10 is installed on the blade holder 20, the RFID tag 111 approaches the RFID reading/writing unit 121 and is then activated. Consequently, the RFID reading/writing unit 121 may establish the wireless communication connection with the RFID tag 111 through radio frequency.

With the established wireless communication connection, the RFID reading/writing unit 121 may receive the ID data 130 from the RFID tag 111, and transmit it to the controller 122.

The ID data 130 is data associated with an authorized manufacturer or an authorized model of the blade dispenser 10. In some embodiments, the ID data 130 is data associated with one or more authorized manufacturers or authorized models. In a preferred embodiment, the ID data 130 is data used for a unique manufacturer or model.

The controller 122 may be configured to communicate with the RFID reader writer 121, and to control the operations of the entire blade holder 20.

Specifically, the controller 122 may receive the ID data 130 from the RFID reading/writing unit 121, compare the ID data 130 with preset authorization data 140, and enable the blade holder 20 to use the blade in the blade dispenser 10 when the ID data 130 matches with the authorization data 140. The authorization data 140 may be pre-stored in the memory 123.

It is noted that if the RFID tag 111 does not support functions such as identity authentication or encryption, the transmitted data may be easily intercepted through a compatible reader. Therefore, preferably, the RFID tag 111 is a smart tag with security functionalities, and may interact with the RFID reading/writing unit 121 intelligently. For example, the RFID tag 111 may encrypt the ID data 130 to be transmitted to the RFID reading/writing unit 121. Especially, the RFID tag 111 may encrypt the ID data 130 through an Advanced Encryption Standard (AES) algorithm, and may perform authentication with a unique key embedded secretly according to Public Key Infrastructure (PM).

In this embodiment, when the ID data 130 is encrypted ID data, the controller 122 may decrypt the encrypted ID data 130 according to a decryption key, and compare the decrypted ID data 130 with the authorization data 140.

The decryption key may be pre-stored in the memory 123. The decryption key may alternatively be pre-stored in a memory other than the memory 123. In other embodiments, the decryption key may be downloaded from a server. Further, in some embodiments, the controller 122 may download the decryption key from the server periodically to update the decryption key stored in the blade holder 20, for example, in the memory 123.

Consequently, even if the ID data 130 is intercepted during the RFID communication, since the decryption key is pre-stored in the blade holder 20, the interceptor could not obtain true ID data, and could not use the intercepted, undecrypted ID data for other purposes. Hence, by combining the ID data verification with the ID data encryption, the security performance of the scheme in the present disclosure may be further improved.

As described above, when the ID data 130 matches with the authorization data 140, i.e., successful authorization verification for the blade dispenser 10, the controller 122 may enable the blade holder 20 to use the blade in the blade dispenser 10.

Specifically, the controller 122 may send a message indicating the successful authorization verification to the blade driver 23 (referring to FIG. 2) in the blade holder 20. Once receiving the message, the blade driver 23 actuates the driving unit 24 to deliver the new blade 12a in the blade dispenser 10 into the blade receptacle 22.

However, if it is not matched, i.e., failure authorization verification for the blade dispenser 10, the controller 122 will not issue the message of successful authorization verification. Consequently, the blade driver 23 could not be actuated such that the blade holder 20 could not use the blade in the unauthorized blade dispenser 10.

Furthermore, when the authorization verification fails, the controller 122 may indicate the blade holder 20 to alarm the user with abnormal conditions. For example, a prompt indicating failure authorization verification may be displayed on a display 124, to prompt the user that the blade dispenser 10 is unauthorized. Hence, the user may choose to replace the blade dispenser 10 or to look for whether there is something wrong with the blade holder system.

Furthermore, when the authorization verification fails, the user may also be allowed to neglect the authorization process, by manually activating the blade driver 23. This is to cope with an emergency case where an authorized blade dispenser is not available for the user temporarily. However, in such a case, the user may be prompted with a warning that the unauthorized blade might lead to problems in cutting qualities.

The display 124 is connected to the controller 122, and may display corresponding prompting information. For example, the blade information extracted from the ID data 130, including the name of the blade manufacturer, the blade model, the date of manufacture, precautions for the use of the blade, or the like, may be displayed on the display 124, to assist the user to learn more about the blade in use. Furthermore, a prompt indicating successful or failure authorization may be displayed to assist the user to perform corresponding operations so as to improve the efficiency of verification. For example, when the blade dispenser 10 is verified successfully as being authorized, a message prompting successful authorization verification may be displayed. According to that message, the user may wait for the blade driver 23 to take out a new blade 12a from the blade dispenser 10 and to install it for further operations, which may improve convenience and security of the operations.

As mentioned above, in the first embodiment of the present disclosure, a blade holder system based on radio frequency identification (RFID) technology is provided, comprising a blade holder including a RFID reading/writing unit and a blade dispenser including a blade and a RFID tag, the RFID tag including the ID data relating to the blade dispenser. By identifying and verifying the blade dispenser installed on the blade holder based on the RFID technology, it is ensured that the blade holder may always be provided with authorized blade dispensers, thereby being capable of maintaining the uniformity of the blades to be used and the consistency and stability of the cutting quality.

### Second Embodiment

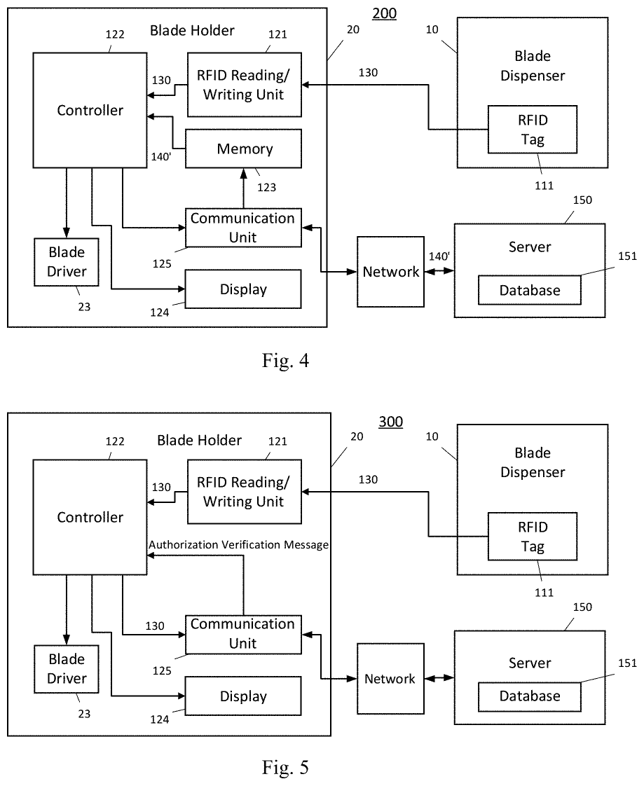

FIG. 4 illustrates a schematic diagram of a blade holder system 200 based on RFID technology according to a second embodiment of the present disclosure. The blade holder system 200 of the second embodiment differs from the blade holder system 100 of the first embodiment mainly in that the blade holder system 200 further comprises a server 150 including a database 151; and, the blade holder 20 further includes a communication unit 125. In the second embodiment, the components similar to those in the first embodiment are referred to with the same reference signs, and repetitive explanation will be omitted.

As shown in FIG. 4, as compared with the blade holder system 100 of the first embodiment illustrated in FIG. 3, the blade holder system 200 further comprises the server 150 including the database 151 in which authorization data 140′ is stored.

Furthermore, the blade holder 20 further includes the communication unit 125 configured to communicate with the server 150 via a network.

The controller 122 may download the authorization data 140′ from the database 151 in the server 150 into the memory 123 or other memory in the blade holder 20 through the communication unit 125.

In some embodiments, the controller 122 may download the authorization data 140 from the server 150′ periodically, to update the authorization data 140 stored in the memory in the blade holder 20, for example, in the memory 123.

Consequently, when the blade dispenser 10 is installed on the blade holder 20, the RFID reading/writing unit 121 may receive the ID data 130 from the RFID tag 111 of the blade dispenser 10, and transmit it to the controller 122. The controller 122 may compare the ID data 130 with the authorization data 140′ obtained from the server 150 and stored, for example, in the memory 123, and when the ID data 130 matches with the authorization data 140′, i.e., successful authorization verification for the blade dispenser 10, enable the blade holder 20 to use the blade in the blade dispenser 10.

The benefits for obtaining the authorization data 140′ from the server 150 through the communication unit 125 lie in that the controller 122 may compare with the latest authorization data 140′ provided by the server 150, thereby avoiding a problem of failing to identify and verify the latest models of the blade dispensers due to lagged authorization data stored in the blade holder 20.

The communication unit 125 may communicate with the server 150 through a wireless fidelity (WiFi) communication unit or a 4G/5G networking communication unit.

In some embodiments, when the ID data 130 is encrypted ID data, the controller 122 may download a decryption key from the server 150, for example, from the database 151, through the communication unit 125.

In some embodiments, the controller 122 may download the decryption key from the server 150 periodically, to update the decryption key stored in a memory in the blade holder 20, for example, in the memory 123.

The benefits for obtaining the decryption key from the server 150 through the communication unit 125 lie in that the decryption key may be obtained in real time or updated periodically from the server 150, which may further prevent the interceptor from obtaining true ID data, and may further improve the security performance of the scheme in the present disclosure.

As mentioned above, in the second embodiment of the present disclosure, a blade holder system based on radio frequency identification (RFID) technology is provided, comprising a blade holder including a RFID reading/writing unit and a blade dispenser including a blade and a RFID tag, the RFID tag including the ID data relating to the blade dispenser. By identifying and verifying the blade dispenser installed on the blade holder based on the RFID technology, it is ensured that the blade holder may always be provided with authorized blade dispensers, thereby being capable of maintaining the uniformity of the blades to be used and the consistency and stability of the cutting quality. Furthermore, in the second embodiment, by obtaining the authorization data from the server through the communication unit, the controller may compare with the latest authorization data provided by the server, thereby avoiding a problem of failing to identify and verify the latest models of the blade dispensers due to lagged authorization data stored in the blade holder. Furthermore, in the second embodiment, by obtaining the decryption key from the server through the communication unit, the decryption key may be obtained in real time or updated periodically from the server, which may further prevent the interceptor from obtaining true ID data, and may further improve the security performance of the scheme in the present disclosure.

### Third Embodiment

FIG. 5 illustrates a schematic diagram of a blade holder system 300 based on RFID technology according to a third embodiment of the present disclosure. The blade holder system 300 of the third embodiment differs from the blade holder system 200 of the second embodiment mainly in that the process for comparing the ID data with the authorization data in the blade holder system 300 is performed in a server remotely. In the third embodiment, the components similar to those in the first and second embodiments are referred to with the same reference signs, and repetitive explanation may be omitted.

It is noted that the illustration of the memory is omitted in FIG. 5 for the sake of concision and clarity of illustration. However, the blade holder system 300 according to the third embodiment may include a memory.

In the first and second embodiments, the process for comparing the ID data 130 with the authorization data 140 (140′) is performed locally in the blade holder 20 under the control of the controller 122. However, in the third embodiment, the above comparing process may be performed in the server 150 remotely.

Specifically, referring to FIG. 5, when the blade dispenser 10 is installed on the blade holder 20, the RFID reading/writing unit 121 may receive the ID data 130 from the RFID tag 111 of the blade dispenser 10, and transmit it to the controller 122.

The controller 122 may transmit the ID data 130 to the server 150 through the communication unit 125.

The server 150 may compare the ID data 130 from the controller 122 with the authorization data 140′ in the database 151, to determine whether the ID data 130 matches with the authorization data 140′, and return the determination result as an authorization verification message back to the controller 122.

The controller 122 receives the authorization verification message from the server 150, and when the authorization verification message indicates successful authorization verification, the controller 122 may enable the blade holder 20 to use the blade in the blade dispenser 10.

The benefits for transmitting the ID data 130 to the server 150 to perform the comparing process lie in that the server 150 may compare with the latest authorization data 140′ stored in the server 150, thereby avoiding a problem of failing to identify and verify the latest models of the blade dispensers due to lagged authorization data stored in the blade holder 20.

Furthermore, since the comparing process is performed at the server 150, computation load at the controller 122 in the blade holder 20 may be reduced greatly. Consequently, the blade holder 20 may be provided with a controller with simple processing capability, thereby allowing for reduced costs and structural complexity.

In some embodiments, when the ID data 130 is encrypted ID data, the server 150 may decrypt the encrypted ID data 130 according to a decryption key stored in the database 151, and compare the decrypted ID data 130 with the authorization data 140′.

In this embodiment, since it is not necessary for the blade holder 20 to store locally or download the decryption key, the computation load at the controller 122 in the blade holder 20 may be reduced greatly. Consequently, the blade holder 20 may be provided with a controller with simple processing capability, thereby allowing for reduced costs and structural complexity. Furthermore, since the decryption process is performed remotely, it may further prevent the interceptor from obtaining true ID data, and further improve the security performance of the scheme in the present disclosure.

As mentioned above, in the third embodiment of the present disclosure, a blade holder system based on radio frequency identification (RFID) technology is provided, comprising a blade holder including a RFID reading/writing unit and a blade dispenser including a blade and a RFID tag, the RFID tag including the ID data relating to the blade dispenser. By identifying and verifying the blade dispenser installed on the blade holder based on the RFID technology, it is ensured that the blade holder may always be provided with authorized blade dispensers, thereby being capable of maintaining the uniformity of the blades to be used and the consistency and stability of the cutting quality. Furthermore, in the third embodiment, by transmitting the ID data to the server to perform the comparing process, the server may compare with the latest authorization data stored in the server, thereby avoiding a problem of failing to identify and verify the latest models of the blade dispensers due to lagged authorization data stored in the blade holder 20. Furthermore, in the third embodiment, by performing the comparing process at the server, computation load at the controller in the blade holder may be reduced greatly. Consequently, the blade holder may be provided with a controller with simple processing capability, thereby allowing for reduced costs and structural complexity. Furthermore, in the third embodiment, by performing the decryption process of the ID data through the server, it is not necessary for the blade holder to store locally or download the decryption key, which further reduces computation load at the controller in the blade holder greatly. Consequently, the blade holder may be provided with a controller with simple processing capability, thereby allowing for reduced costs and structural complexity. Furthermore, in the third embodiment, by performing the decryption process remotely, it may further prevent the interceptor from obtaining true ID data, and further improving the security performance of the scheme in the present disclosure.

### Fourth Embodiment

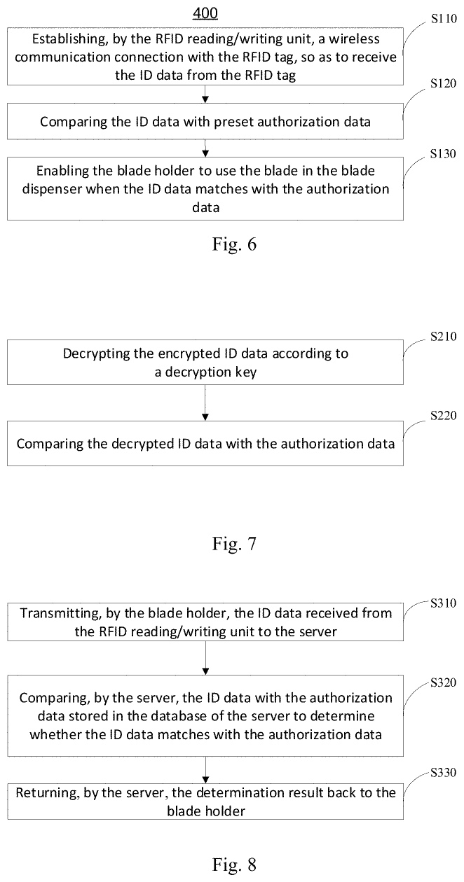

FIG. 6 illustrates a flow chart of a method 400 for controlling a blade holder system based on RFID technology according to a fourth embodiment of the present disclosure.

Referring to FIGS. 3-5, the blade holder system 100 comprises the blade dispenser 10 and the blade holder 20. The blade holder 20 includes the radio frequency identification (RFID) reading/writing unit 121. The blade dispenser 10 includes the blade and the radio frequency identification (RFID) tag 111, the RFID tag 111 including the ID data relating to the blade dispenser 10.

As shown in FIG. 6, the controlling method 400 comprises the following steps.

At step S110, the RFID reading/writing unit 121 may establish a wireless communication connection with the RFID tag 111 to receive the ID data 130 from the RFID tag 111.

At step S120, the ID data 130 may be compared with preset authorization data 140.

At step S130, when the ID data 130 matches with the authorization data 140, the blade holder 20 may be enabled to use the blade in the blade dispenser 10.

As explained previously, the ID data 130 is data associated with an authorized manufacturer or an authorized model of the blade dispenser 10. In some embodiments, the ID data 130 is data associated with one or more authorized manufacturers or authorized models. In a preferred embodiment, the ID data 130 is data used for a unique manufacturer or model.

The step S120 may further comprise: installing the blade dispenser 10 on the blade holder 20; and detecting whether there is a RFID tag 111 within a preset range, and establishing the wireless communication connection with the detected RFID tag 111, by the RFID reading/writing unit 121.

As described above, if the RFID tag 111 does not support functions such as identity authentication or encryption, the transmitted data may be easily intercepted through a compatible reader. Therefore, in some embodiments the RFID tag 111 may encrypt the ID data 130 to be transmitted to the RFID reading/writing unit 121.

In this case, as shown in FIG. 7, the step S120 may further comprises the following steps for decrypting the encrypted ID data 130. FIG. 7 illustrates a flow chart of a method for decrypting the encrypted ID data 130 according to an embodiment of the present disclosure.

At step 210, the encrypted ID data 130 may be decrypted according to a decryption key.

At step S220, the decrypted ID data 130 may be compared with the authorization data 140 (140′).

Further, as described above, in some embodiments, the process for comparing the ID data 130 with the authorization data 140 (140′) may be performed remotely at the server 150.

In this case, as shown in FIG. 8, the step S120 may further comprises the following steps for implementing the method for controlling the blade holder system with a remote server. FIG. 8 illustrates a flow chart of a method for controlling a blade holder system implemented with a remote server according to an embodiment of the present disclosure.

At step 310, the ID data 130 received from the RFID reading/writing unit 121 may be transmitted to the server 150, by the blade holder 20.

At step 320, the ID data 130 may be compared with the authorization data 140′ stored in the database 151 by the server 150, to determine whether the ID data 130 matches with the authorization data 140′.

At step 330, the determination result may be returned back to the blade holder 20 by the server 150.

As mentioned above, in the fourth embodiment of the present disclosure, a method for controlling a blade holder system based on RFID technology is provided, which comprises a blade holder including a RFID reading/writing unit and a blade dispenser including a blade and a RFID tag, the RFID tag including ID data relating to the blade dispenser. By identifying and verifying the blade dispenser installed on the blade holder based on the RFID technology, it is ensured that the blade holder may always be provided with authorized blade dispensers, thereby being capable of maintaining the uniformity of the blades to be used and the consistency and stability of the cutting quality.

### Fifth Embodiment

To implement the above embodiments, the present disclosure further proposes an electronic device, including one or more processors and a storage device configured to store one or more programs. The processor may read out executable program codes stored in the memory to execute a program corresponding to the executable program codes for implementing the control method according to the above embodiments.

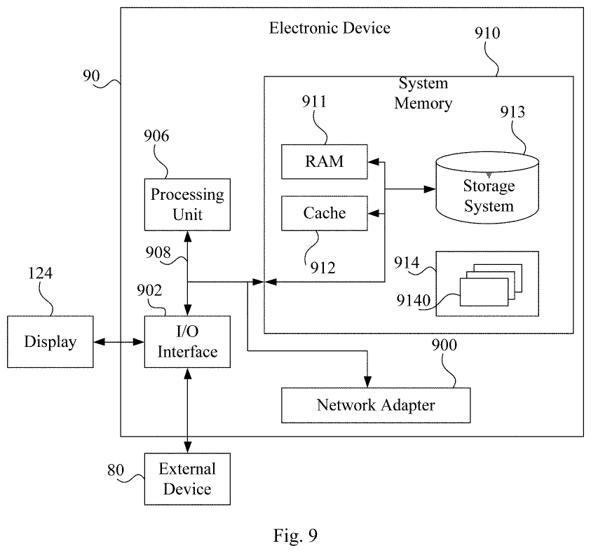

FIG. 9 illustrates a schematic diagram of the electronic device according to an embodiment of the present disclosure, which is a block diagram of an exemplary electronic device 90 adapted for implementing the embodiments of the present disclosure. The electronic device 90 shown in FIG. 9 is merely an example and is not intent to impose any limitation on the function and usage of the embodiments of the present disclosure.

As illustrated in FIG. 9, the electronic device 90 is implemented as a general-purpose computer device. Components of the electronic device 90 may include, but not limited to, one or more processors or processing units 906, a system memory 910, and a bus 908 connecting various system components (including the system memory 910 and the processing unit 906).

The bus 908 may be implemented as one or more bus architectures, including a storage device bus or a storage device controller, a peripheral bus, an accelerated graphics port, a processor, or a local bus with any of the bus architectures. For example, the bus architectures include, but not limited to, an industry subversive alliance (ISA) bus, a micro channel architecture (MAC) bus, an enhanced ISA bus, a video electronics standards association (VESA) local bus and a peripheral component interconnect (PCI) bus.

The electronic device 90 typically includes various computer system readable media. These media may be any available medium that may be accessed by the electronic device 90, including volatile and non-volatile media, removable and non-removable media.

The system memory 910 may include a computer system readable medium in the form of a volatile memory, such as a random access memory (RAM) 911 and/or a cache memory 912. The electronic device 90 may further include other removable/non-removable and volatile/non-volatile computer system storage media. As an example only, a storage system 913, may be configured to read from or write to a non-removable and non-volatile magnetic medium (not shown in FIG. 9, and generally referred as a “hard disk drive”). Although not shown in FIG. 9, a magnetic-disk drive configured to read from or write to a removable and nonvolatile magnetic disk (for example, a “floppy disk”), and an optical-disk drive configured to read from or write to a removable and nonvolatile optical disk, such as a compact disc read-only memory (CD-ROM), a digital video disc-read only memory (DVD-ROM), or other optical media, may be provided. In those cases, each driver may be connected to the bus 908 through one or more data medium interfaces. The system memory 910 may include at least one program product having a set of (e.g., at least one) program modules configured to perform functions in respective embodiments of the present disclosure.

A computer readable signal medium may include a data signal that is propagated in a baseband or as part of a carrier, carrying computer readable program codes. The data signal propagated in this manner may adopt a plurality of forms including, but not limited to, an electromagnetic signal, an optical signal, or any suitable combination thereof. The computer readable signal medium may also be any computer readable medium other than a computer readable storage medium. The computer readable medium may send, propagate, or transmit a program to be utilized by or in connection with an instruction execution system, apparatus, or device.

Program codes contained in the computer readable medium may be transmitted over any suitable media, including but not limited to a wireless connection, a wired connection, a fiber optic cable, RF, or any suitable combination thereof.

Computer program codes for performing the operations of the present disclosure may be written in one or more programming languages, or a combination thereof, including an object-oriented programming language such as Java, Smalltalk, C++, and conventional procedural programming languages such as the C language or the like. The program codes may be entirely executed on the user's computer, partly executed on the user's computer, executed as a stand-alone software package, executed partly on the user's computer and partly on a remote computer, or entirely executed on the remote computer or terminal.

A program/utility 914 including a set of (at least one) program modules 9140 may be stored, for example, in the system memory 910. Such program modules 9140 include, but not limited to, an operation system, one or more applications, other program modules and program data. Each or a certain combination of the examples may include an implementation of a network environment. The program module 9140 typically performs the functions and/or methods in the embodiments described herein.

The electronic device 90 may further communicate with one or more external devices 80, such as a keyboard, a pointing device, a display 124, or the like, and may also communicate with one or more terminals that enable the user to interact with the terminal device 90, and/or communicate with any terminals, such as a network card, a modem, or the like, that enable the electronic device 90 to communicate with one or more other computer terminals. Such communication may be implemented through an input/output (I/O) interface 902. In addition, the electronic device 90 may also communicate with one or more networks, such as a local area network (LAN), a wide area network (WAN), and/or a public network, such as the Internet, through the network adapter 900. As shown in FIG. 9, the network adapter 900 communicates with other modules of the electronic device 90 through the bus 908. It should be understood that although not shown in FIG. 9, other hardware and/or software modules may be utilized in combination with the electronic device 90, including but not limited to: a microcode, a terminal driver, a redundant processor, an external disk drive array, a redundant-arrays-of-independent-disks (RAID) system, a tape drive, and a data backup storage system.

The processing unit 906 performs various functional applications and data processing by running programs stored in the system memory 910, for example, for implementing the control method mentioned in the above embodiments.

To implement the above embodiments, the present disclosure further proposes a non-transitory computer readable storage medium having a computer program stored thereon, wherein when the program is executed by a processor, the program implements the control method according to the above embodiments of the present disclosure.

To implement the above embodiments, the present disclosure further proposes a computer program product for implementing the control method according to the above embodiments of the present disclosure when instructions in the computer program product is executed by a processor.

Throughout the description of the present disclosure, terminologies “an embodiment”, “some embodiments”, “an example”, “a specific example”, or “some examples”, means that features, structures, materials, or characteristics described in connection with the embodiment(s) or example(s) may be included in at least one embodiment or example of the present disclosure. Thus, the illustrative description for the above terminologies in this disclosure is not necessarily directed to the same embodiment or example. Furthermore, the specific features, structures, materials, or characteristics described herein may be combined in any suitable manner in one or more embodiments or examples. If not contradictory, different embodiments or examples and features in the different embodiments or examples may be combined by those skilled in the art.

In addition, terminologies such as “first” and “second” are used herein for purposes of description and are not intended to indicate or imply relative importance or significance, or indicate or imply the number of the indicated technical features. Furthermore, the feature defined with “first” and “second” may comprise at least one of the features distinctly or implicitly. In the description of the present disclosure, “a plurality of” means at least two, such as two or three, unless stated definitely and specifically.

Any process or method described in the flow charts or described in any other way herein may be understood as including one or more modules, sections or parts of executable codes for implementing custom logic functions or procedures. Moreover, preferred embodiments of the present disclosure comprises other implementations in which the functions may be performed in an order rather than the order depicted or discussed, including in a substantially simultaneous manner or in an inversed order according to the related functions, which should be understood by those skilled in the art.

The logics and/or steps shown in the flow chart or in other manners described herein, for example, may be regarded as an ordered list of executable instructions for implementing the logical functions, and may be embodied in any computer readable medium to be used by an instruction execution system, apparatus or device, such as a system based on a computer, a system including processors, or other systems capable of fetching and executing instructions from the instruction execution system, apparatus or device, or to be used in combination with the instruction execution system, apparatus or device. Here, the terminology “computer readable medium” may refer to any means configured for containing, storing, communicating, propagating or transmitting programs to be used by or in combination with the instruction execution system, apparatus or device. More specific examples of the computer readable medium comprise but not exhaustively: an electronic connection (an electronic device) with one or more wires, a portable computer disk cartridge (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even include a paper or other appropriate medium with those programs printed thereon, which, for example, may be optically scanned and then edited, interpreted or processed in other appropriate way when necessary so as to obtain the programs in an electrical manner and to store it in the computer memories.

It should be understood that respective parts of the present disclosure may be implemented by hardware, software, firmware or a combination thereof. In the above embodiments, a plurality of steps or methods may be implemented by software or firmware stored in a memory and executed by an appropriate instruction execution system. For example, if it is implemented by hardware, as in another embodiment, it may be implemented by any one of the following techniques known in the art or a combination thereof: a discrete logic circuit including logic gate circuits for implementing logic functions for data signals, an application-specific integrated circuit including an appropriate combination of logic gate circuits, a programmable gate array (PGA), a field programmable gate array (FPGA), etc.

Those skilled in the art may understand that all or part of the steps in the above methods according to the embodiments of the present disclosure may be implemented by instructing relevant hardware through programs. The programs may be stored in a computer readable storage medium, and implement one of the steps in the method according to embodiments of the present disclosure, or a combination thereof, when it is executed.

In addition, respective functional units in respective embodiments of the present disclosure may be integrated in one processing module, or may be presented as physically separated units, or may be implemented as two or more unites integrated in one module. The above integrated module may be implemented in hardware or as a software functional module. When the integrated module is implemented as a software function module and is sold or used as a standalone product, it may be stored in a computer readable storage medium.

The storage medium mentioned above may be read-only memories, magnetic disks, CDs, etc. Although explanatory embodiments have been illustrated and described, it is to be understood that the above embodiments are only illustrative and should not be construed to limit the present disclosure. Those skilled in the art may make changes, alternatives, and modifications to the embodiments without departing from the spirit, principles and scope of the present disclosure.

1. A blade holder system, comprising:
a blade dispenser, including a blade and a radio frequency identification (RFID) tag, the RFID tag including ID data relating to the blade dispenser; and
a blade holder, including:
a radio frequency identification (RFID) reading/writing unit, configured to establish a wireless communication connection with the RFID tag so as to receive the ID data from the RFID tag; and
a controller, configured to receive the ID data from the RFID reading/writing unit, to compare the ID data with preset authorization data, and to enable the blade holder to use the blade in the blade dispenser when the ID data matches with the authorization data.

2. The system according to claim 1, wherein the ID data is data associated with an authorized manufacturer or an authorized model of the blade dispenser.

3. The system according to claim 1, wherein the blade dispenser is installed on the blade holder, and
the RFID reading/writing unit detects whether there is a RFID tag within a preset range, and establishes the wireless communication connection with the detected RFID tag.

4. The system according to claim 1, wherein the blade holder further includes:
a blade receptacle configured to receive and secure the blade; and
a blade driver, including a driving unit connected to the blade dispenser,
wherein the controller sends a message indicating successful authorization verification to the blade driver when the ID data matches with the authorization data, and
once receiving the message, the blade driver actuates the driving unit to deliver the blade in the blade dispenser into the blade receptacle.

5. The system according to claim 1, wherein the blade holder further includes a first memory in which the authorization data is pre-stored.

6. The system according to claim 1, further comprising a server including a database in which the authorization data is stored;
wherein, the blade holder further includes a second memory, and a communication unit configured to communicate with the server via a network, and
wherein, the controller downloads the authorization data from the database in the server into the second memory through the communication unit.

7. The system according to claim 6, wherein the controller downloads the authorization data from the server periodically, to update the authorization data in the second memory.

8. The system according to claim 1, wherein the RFID tag encrypts the ID data to be transmitted to the RFID reading/writing unit.

9. The system according to claim 8, wherein the controller decrypts the encrypted ID data according to a decryption key, and compares the decrypted ID data with the authorization data.

10. The system according to claim 9, wherein the decryption key is pre-stored in a first memory or a second memory.

11. The system according to claim 9, wherein the decryption key is downloaded from a server by the controller.

12. The system according to claim 11, wherein the controller downloads the decryption key from the server periodically, to update the decryption key in a second memory.

13. The system according to claim 1, wherein the blade holder further includes a display connected to the controller and configured to display a prompt to indicate failure authorization verification when the ID data does not match with the authorization data.

14. A blade holder system, comprising:
a blade dispenser including a blade and a radio frequency identification (RFID) tag, the RFID tag including ID data relating to the blade dispenser;
a server including a database in which authorization data is stored; and
a blade holder, including:
a radio frequency identification (RFID) reading/writing unit, configured to establish a wireless communication connection with the RFID tag so as to receive the ID data from the RFID tag;
a communication unit, configured to communicate with the server via a network; and
a controller, configured to receive the ID data from the RFID reading/writing unit, to transmit the received ID data to the server through the communication unit, to receive an authorization verification message from the server, and to enable the blade holder to use the blade in the blade dispenser when the authorization verification message indicates successful authorization verification,
wherein, the server receives the ID data from the controller, compares the ID data with the authorization data in the database to determine whether the ID data matches with the authorization data, and returns the determination result as the authorization verification message back to the controller.

15. The system according to claim 14, wherein the RFID tag encrypts the ID data to be transmitted to the RFID reading/writing unit.

16. The system according to claim 15, wherein when the ID data is encrypted ID data, the server decrypts the encrypted ID data according to a decryption key stored in the database, and compares the decrypted ID data with the authorization data.

17. A method for controlling a blade holder system, the blade holder system comprising a blade holder including a radio frequency identification (RFID) reading/writing unit and a blade dispenser including a blade and a radio frequency identification (RFID) tag, the RFID tag including ID data relating to the blade dispenser, the method comprising:
establishing, by the radio frequency identification (RFID) reading/writing unit, a wireless communication connection with the RFID tag, so as to receive the ID data from the RFID tag;
comparing the ID data with preset authorization data; and
enabling the blade holder to use the blade in the blade dispenser when the ID data matches with the authorization data.

18. The method of claim 17, wherein the ID data is data associated with an authorized manufacturer or an authorized model of the blade dispenser.

19. The method of claim 17, wherein establishing, by the RFID reading/writing unit, the wireless communication connection with the RFID tag, comprises:
installing the blade dispenser on the blade holder; and
detecting, by the RFID reading/writing unit, whether there is a RFID tag within a preset range, and establishing the wireless communication connection with the detected RFID tag.

20. The method of claim 17, further comprising: encrypting, by the RFID tag, the ID data to be transmitted to the RFID reading/writing unit.

21. The method according to claim 20, wherein comparing the ID data with the preset authorization data, comprising:
decrypting the encrypted ID data according to a decryption key; and
comparing the decrypted ID data with the authorization data.

22. The method according to claim 20, wherein comparing the ID data with the preset authorization data, comprising:
transmitting, by the blade holder, the ID data received from the RFID reading/writing unit to a server;
comparing, by the server, the ID data with authorization data stored in a database of the server to determine whether the ID data matches with the authorization data; and
returning, by the server, the determination result back to the blade holder.

23. An electronic device, comprising:
one or more processors, and
a storage device, configured to store one or more programs,
wherein, when the one or more programs are executed by the one or more processors, the one or more processors are configured to implement the method for controlling a blade holder system according to claim 17.

24. A computer readable storage medium having a computer program stored thereon, wherein, when the program is executed by a processor, the program implements the method for controlling a blade holder system according to claim 17.
